(19) United States
(12) Patent Application Publication
(10) Pub. No.: US 2010/0001844 A1
(43) Pub. Date: Jan. 7, 2010

(54) System and Method for Receiving Wireless Data

(76) Inventors: Alex BAHEL, San Jose, CA (US); John Sellin, Morgan Hill, CA (US); Ajay Malik, Santa Clara, CA (US)

Correspondence Address: FAY KAPLUN & MARCIN, LLP, 150 BROADWAY, SUITE 702, NEW YORK, NY, 10038, US

(21) Appl. No.: 12/166,563

(22) Filed: Jul. 2, 2008

(51) Int. Cl. H04Q 5/22

(52) U.S. Cl. 340/10.4

(57) ABSTRACT

A device for receiving data comprises a communications arrangement, a memory, and a processor. The communications arrangement receives user-programmable subscription data. The memory stores the subscription data and configuration data. The processor receives activity data corresponding to a movement of an object and generates a report from the activity data as a function of the configuration data. The report includes information indicative of the movement of the object from a first location to a second location and is transmitted from the device to a client device in accordance with the subscription data.

### FIELD OF INVENTION

The present application generally relates to systems and methods for receiving data.

### BACKGROUND INFORMATION

Physical objects can be wirelessly monitored by using data received from a wireless communication to determine a location of an object. One method of wireless communication involves transmitting radio-frequency (“RF”) signals between an object and a tracking device that monitors the object. In some instances, the object may be an electronic device capable of wireless communication. However, in other instances, the object may not be capable of wireless communication at all (e.g., a non-electronic device or a simple electronic device). In these latter instances, wireless capabilities may be added by attaching an RF identification (RFID) tag to the object.

RFID tags may be utilized in conjunction with RFID readers that determine the presence of the RFID tag when the tag is placed within proximity to the reader's antenna. The tag and reader may be deployed in an environment that includes one or more locations that are monitored. In such an environment, it may be desirable to monitor an object's movement by determining when the object moves from one location or zone to another. In a conventional wireless monitoring arrangement, one or more RFID readers are used to communicate with an RFID tag and generate activity data that may be collected and subsequently analyzed by a computing device. In the conventional monitoring arrangement, a report may be generated each time the object enters or exits a location. The computing device processes a plurality of such reports to determine a status of the object. Because report data may be numerous, the computing device may perform unnecessary processing, resulting in inefficient use of computing resources such as memory or processing ability.

### SUMMARY OF THE INVENTION

The present invention relates to a device and method for receiving data. The device comprises a communications arrangement, a memory, and a processor. The communications arrangement receives user-programmable subscription data. The memory stores the subscription data and configuration data. The processor receives activity data corresponding to a movement of an object and generates a report from the activity data as a function of the configuration data. The report includes information indicative of the movement of the object from a first location to a second location and is transmitted from the device to a client device in accordance with the subscription data.

### BRIEF DESCRIPTION OF THE DRAWINGS

FIG. 1 shows a system according to an exemplary embodiment of the present invention.

FIG. 2 shows a block diagram of a wireless switch according to the present invention.

FIG. 3 shows an exemplary method according to the present invention.

### DETAILED DESCRIPTION

The exemplary embodiments of the present invention may be further understood with reference to the following description and the appended drawings, wherein like elements are provided with the same reference numerals. The exemplary embodiments of the present invention relate to systems and methods for receiving wireless data. The exemplary embodiments of the present invention will be described with reference to an RF switch. However, those skilled in the art will understand that the present invention may also be implemented in any computing device that is configured to receive and process wireless data. Thus, other embodiments may include other computing devices such as a router, a dedicated server, a wireless switch, a locationing appliance, etc.

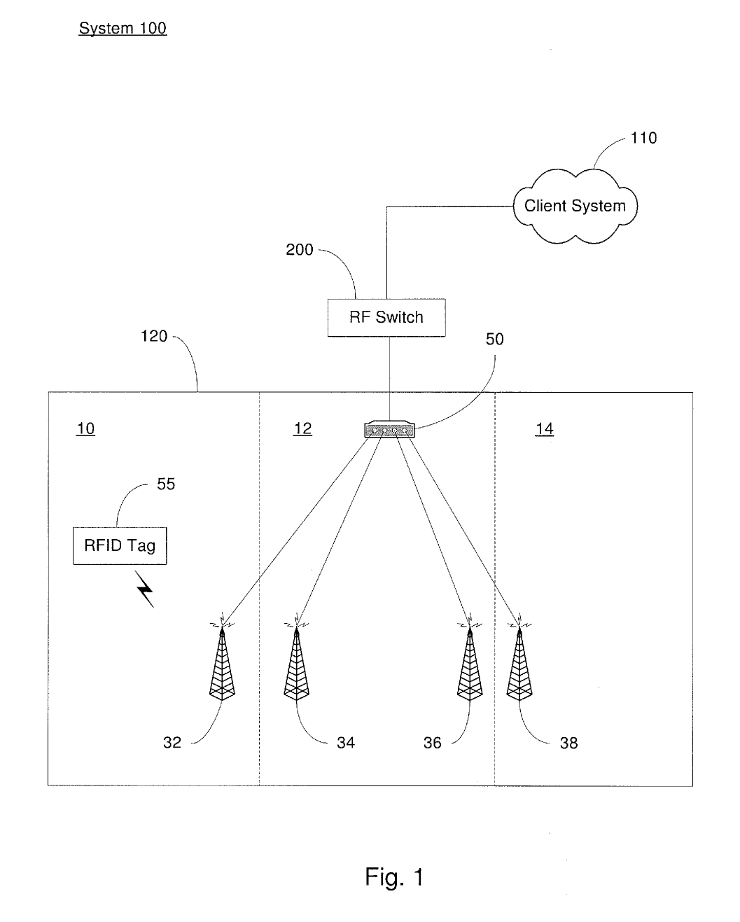

FIG. 1 shows an exemplary embodiment of a system 100 according to the present invention. The system 100 may include a client system 110 communicatively coupled to an RF switch 200. The system 100 may further include a monitored location 120, which may be subdivided into a plurality of zones 10, 12 and 14. Each of the zones 10-14 may include an RF communications arrangement that transmits and receives RF signals. For example, the zones 10-14 may respectively include RF antennas 32, 34, 36 and 38, which may receive signals from an RFID reader 50 and an RFID tag 55.

In the exemplary embodiment of FIG. 1, the antennas 32-38 are shown as being hardwired to a port of the RF reader 50. Thus, the RFID reader 50 will generate, for example, an RFID interrogation signal which will be relayed to the antennas 32-38 and then transmitted into the corresponding zone 10-14. The antennas 32-38 will also receive RF signals from the RFID tag 55. The RF signals received from the RFID tag 55 may be a response from the RFID interrogation signal. The RF signals from the RFID tag 55 may be transmitted to the RFID reader 50. The RFID reader 50 may process the RF signals or may transmit the RF signals to a network component.

The tag 55 may be attached to an object being monitored by the client system 110. The object may be virtually any physical object capable of being relocated. For example, if the location 120 is a warehouse, the object may be a package or a piece of equipment that needs monitoring. The tag 55 may include either an active, a passive, or a semi-passive RF communications arrangement that transmits tag data to a nearby antenna 32-38. The tag data may, for example, include a unique tag identifier that distinguishes the tag 55 from other tags. In one exemplary embodiment, the tag data may simply be an acknowledgement signal that indicates the tag 55 is within a vicinity of one or more of the antennas 32-38. For example, the tag data may comprise part of a handshake procedure in which the tag 55 and the one or more antennas 32-38 acknowledge each other.

The client system 110 may be any combination of hardware and/or software devices that operate to request information about the tag 55. For example, the client 110 may include a server running a database application. In one exemplary embodiment, the client 110 may also include a network of computing devices (e.g., desktop computers, laptops, mobile computers, etc.) communicatively coupled to a server. Thus, the client 110 may be a private network such as an inter- or intra-company network, a local-area network, etc. The client 110 may also be communicatively coupled to further networks (e.g., the Internet).

The antennas 32-38 may be placed in a substantially fixed position by, for example, attaching the antennas 32-38 to a permanent fixture such as a wall, a column, a doorway, etc. The antenna locations may correspond to borders between zones. For example, the antenna 32 may be located within the zone 10 near a border between the zone 10 and the zone 12, while the antenna 34 may be located within the zone 12 near the same border. Similarly, the antenna 36 may be located in the zone 12 near a border between the zone 12 and the zone 14, while the antenna 38 may be located within the zone 14 near the same border. The borders between the zones 10-14 may be actual physical borders (e.g., a wall, a passageway, a collection of objects, etc.) or a virtual border (e.g., an imaginary subdivision of the location 120. The distance between each antenna 32-38 and a nearby border may vary depending on any number of factors including antenna strength, a transmitting power of the RFID reader 50, an antenna broadcast range, etc. In one embodiment, the antennas 32-38 may be placed such that a range of detection of neighboring antenna pairs (e.g., the antennas 32 and 34 or the antennas 36 and 38) overlaps. In another embodiment, the detection range of each antenna 32-38 may not overlap with any other antenna 32-38. Those skilled in the art will understand that any number of antenna arrangements may be suitable for implementation with the exemplary embodiments of the present invention so long as the placement of the antennas 32-38 enables a determination of when the tag 55 moves from one zone to another.

Each of the antennas 32-38 may be capable of direct wireless communication with the tag 55 within range and direct wired communication with the reader 50. When the tag 55 enters the detection range of one of the antennas 32-38, the antennas 32-38 may detect the presence of the tag 55 (e.g., after performing the handshake procedure). Having detected the tag 55, the antenna 32-38 that detected may then proceed to transmit a signal to the RF reader 50 indicating the detection. In this manner, anytime the tag 55 is within the detection range of any antenna 32-38, the RFID reader 50 may receive signals indicative of the presence of the tag 55 within one of the zones 10-14.

The reader 50 may include a wired connections to each of the antennas 32-38 to enable communicating with the antennas 32-38. The reader 50 may also include hardware and/or software components for processing the signals received form the antennas 32-38. For example, the reader 50 may include a processing arrangement that interprets the received signals to generate activity data.

An exemplary embodiment of the present invention may operate in accordance with one or more reporting standards. For example, the system 100 may operating according to the Application Level Events (“ALE”) specification set forth by EPCglobal Inc. The ALE standard supports client requests for information regarding movements of electronic product codes (“EPCs”) located on RFID tags. Under the ALE standard, read cycles from one or more readers are grouped together to form an event cycle. Activity reports may comprise data about the event cycle. Currently, the ALE standard defines several types of event cycles via a user-definable data type, ECSpec. These event cycle types are defined to include all EPCs read in a current event cycle (e.g., “CURRENT/”), all EPCs added from a previous event cycle (e.g., “ADDITIONS”) and all EPCs deleted from the previous event cycle (e.g., “DELETIONS”). The exemplary embodiments of the present invention may specify new report types based on these addition event cycle type definitions. As will be described in detail below, the present invention may be implemented in a substantially similar manner to ALE. However, it should be noted that the exemplary embodiments of the present invention are not dependent upon ALE or definitions defined therein. That is, other standards including proprietary standards may also be used.

The switch 200 may be coupled to the RFID reader 50 and the client system 110 via any wired or wireless arrangement. The switch 200 may function as an intermediary between the RFID reader 50 and the client system 110 by communicating client requests for activity data to the RFID reader 50, generating activity reports from the activity data received from the RFID reader 50, and transmitting the reports to the client system 110. The switch 200 may be coupled to any number of readers 50 receiving activity data from different locations. Thus, the system 100 may be adapted to monitor locations of varying size or for simultaneous monitoring of multiple locations that are remotely located. The switch 200 may provide a single programming interface using XML/TCP in a substantially similar manner the way ALE works for the applications.

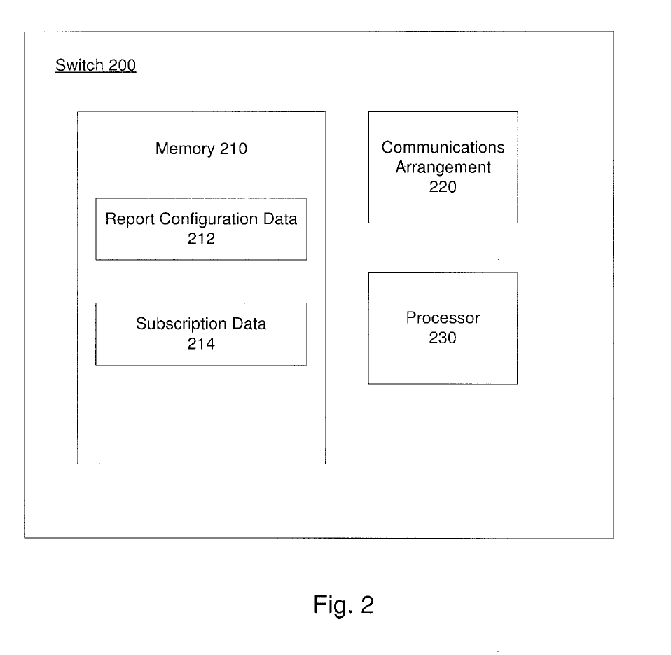

FIG. 2 shows a block diagram of an exemplary embodiment of the switch 200 according to the present invention. The switch 200 may include a memory 210, a communications arrangement 220 and a processor 230. The communications arrangement 220 may include any hardware and/or software arrangement for communication with the RFID reader 50 and the client system 110. For example, if the switch 200 is wired to the RFID reader 50, the communications arrangement 220 may comprise one or more hardware ports (e.g., Ethernet, USB, Serial port, etc.). Similarly, if the switch 200 is in wireless communication with the client system 110, the communications arrangement may include a wireless transceiver communicating in accordance with a wireless standard (e.g., IEEE's 802.11g).

The processor 230 may be a microprocessor, an embedded controller, an application-specific integrated circuit or any other processing component. The processor 230 may be coupled to the memory 210 and the communications arrangement 210 such that configuration data stored in the memory 210 may be read by the processor 230 to operate the communications arrangement 220.

The memory 210 may be any combination of readable and/or writeable memory (e.g., RAM, DRAM, Flash memory, EPROM, etc.). The memory 210 may include other storage mediums such as a hard drive or a compact disc. As discussed above, the memory 210 may contain configuration data (e.g., report configuration data 212 and subscription data 214). The report configuration data 212 may specify a report type (e.g., “MOVE”), which indicates that a tag (e.g., the tag 55) has moved from one location to another (e.g., from the zone 10 to the zone 12). The MOVE report may include data indicative of a direction of movement. For example, the MOVE report may include a data field indicating a location from which the tag 55 has moved (e.g., “FROM”) and a location to which the tag 55 has moved (e.g., “TO”). The MOVE report may be generated by the RF switch 200 from the activity data of the RFID reader 50.

The subscription data 214 may indicate what types of reports the client system 110 has requested. For example, the client system 110 may request a one-time subscription to all tag additions and deletions from the RF reader 50. In another embodiment, the client system 110 may request a long-term subscription to scheduled reports generated at periodic intervals (e.g., once every hour, twice a day, weekly, etc.). Both the one-time subscriptions and the long-term subscriptions may include any combination of report types (e.g., addition, deletion, current and move). The subscription data 214 may be updated and/or generated by a user at the client system 110, either directly at the switch 200 (e.g., via a physical user interface such as a keypad or a data port) or remotely via a device within the client 110 (e.g., transmitting the subscription data 214 via a remote client application running on a desktop computer).

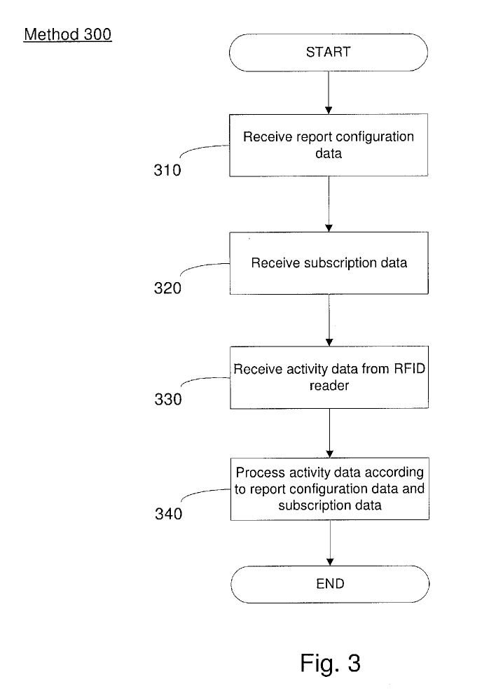

FIG. 3 shows an exemplary embodiment of a method 300 according to the present invention. The method 300 will be described with reference to the switch 200. However, in other embodiments, the method 300 may be implemented at any other computing device that is configured to receive the activity data and subscription data 214 and transmit the reports to the client system 110.

In step 310, the switch 200 receives the report configuration data 212. This may be performed in any number of ways, including uploading the report configuration data 212 directly onto the RF switch 200 (e.g., via the data port), manually inputting the report configuration data 212 and uploading the report configuration data 212 via the client system 110. The step 310 may be performed at any time, such as during manufacture of the RF switch 200 or after manufacture (e.g., during a software or firmware update, during user-programming, etc.). As discussed above, the report configuration data 212 may specify one or more report types (e.g., addition, deletion, current and move). The exemplary embodiments of the present invention may include at least the MOVE reports. However, there is no limit to the number of different report types that may be included in the report configuration data 212.

In step 320, the RF switch 200 receives the subscription data 214 from the user. The receiving of the subscription data 214 may be performed in a manner similar to that of step 310. That is, the subscription data 214 may be uploaded directly onto the RF switch 200, manually inputted, uploaded via the client system 110, etc. For example, in one exemplary embodiment, the client system 110 may transmit the subscription data 214 via the client application, which may include a user interface (e.g., a graphical user interface) for receiving subscription requests from the user. Once step 320 is complete, the RF switch 200 has been fully configured and is ready to receive the activity data.

In step 330, the RF switch 200 receives the activity data from the RFID reader 50, which produces the activity data in accordance with the movement of the tag 55. For example, if the tag 55 is stationary and within the detection range of an antenna (e.g., the antenna 32), then the RFID reader 50 may continually produce activity data indicative of the detection of activity near the antenna 32. Similarly, if the tag 55 moves from the zone 10 to the zone 12, then the reader 50 may produce activity data indicative of a cessation of activity near the antenna 32 in conjunction with an initiation of activity near the antenna 34.

In step 340, the RF switch 200 processes the activity data in accordance with the report configuration data 212 and the subscription data 214. For example, if the report configuration data 312 includes additions, then the switch 200 may generate an ADDITION report when an addition has occurred during a current event cycle. DELETION, CURRENT, and MOVE reports may be similarly produced if criteria for the event types corresponding to these reports occur.

In addition, the generation of reports may depend on the type of subscription requested by the client system 110, as indicated by the subscription data 214. For example, the client system 110 may request periodic updates of ADDITION and DELETION reports. As described above, the request may be a one-time subscription or a long-term subscription. The RF switch 200 may operate so as to only transmit those reports which the client system 110 has requested, and at a frequency or during a time specified in the request.

The exemplary embodiments of the present invention described herein may enable substantial benefits to the client system 110 compared to a conventional monitoring arrangement. A conventional monitoring arrangement would require a client to subscribe to reports from each location being monitored. Thus the client may be required to subscribed to every ADDITION, DELETION and/or CURRENT report generated by a computing device implementing the support for monitoring. This requirement is necessary in order for the client to be able to determine a status of an object being monitored. For example, in order to determine when the object has moved from a first location to a second location, the client must receive a DELETION report corresponding to the first location and an ADDITION report corresponding to the second location.

The exemplary embodiments of the present invention reduce the amount of traffic sent to the client system 110 in addition to reducing the amount of processing that the client system 110 is required to perform. Because additional information (e.g., TO and/or FROM) is included within a new report type (e.g., the MOVE report), the client system 110 may not be required to subscribe to as many reports as would be the case in the conventional monitoring arrangement. For instance, in some embodiments, the client system 110 may only subscribe to MOVE reports from each of the zones 10-14, to each zone, or both. Thus, only three report subscriptions (e.g., a MOVE report corresponding to movement between the zones 10 and 12, a MOVE report corresponding to movement between the zones 10 and 14, and a MOVE report corresponding to movement between the zones 12 and 14) may be required in order for the client system 110 to accurately determine the status of the tag 55.

Although the exemplary embodiments of the present invention have been described with reference to the ALE standard, other standards or methods for reporting monitoring activity and handling requests for those reports may also be utilized as an alternative to the ALE standard. For example, it may be possible to implement the present invention using a proprietary standard.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
a communications arrangement receiving user-programmable subscription data;
a memory storing the subscription data and configuration data; and
a processor receiving activity data corresponding to a movement of an object and generating a report from the activity data as a function of the configuration data,
wherein the report includes information indicative of the movement of the object from a first location to a second location and is transmitted from the device to a client device in accordance with the subscription data.

2. The device of claim 1, wherein the activity data is generated from a remote device.

3. The device of claim 2, wherein the remote device is a radio frequency identification (RFID) reader.

4. The device of claim 3, wherein the object is an RFID tag.

5. The device of claim 4, wherein the first location includes a first antenna and the second location includes a second antenna, the first and second antennas being connected to the device.

6. The device of claim 5, wherein the first and second antennas are configured to receive a first RF signal from the RFID reader to be broadcast in the respective location, the first and second antennas further configured to receive a second RF signal from the tag, the second RF signal being a response to the first RF signal, the second RF signal being transmitted to the RFID reader.

7. The device of claim 1, wherein the report is generated upon the remote device requesting the report from the device.

8. The device of claim 1, wherein the report is one of an application level events report utilizing one of a XML reporting format and a TCP reporting format.

9. The device of claim 8, wherein the report includes one of an addition report, a deletion report, and a current report.

10. The device of claim 9, wherein the subscription data indicates the generation of at least one of the addition report, the deletion report, and the current report.

11. A method, comprising:
receiving a subscription request from a client device for a report indicative of movement of an object;
receiving activity data corresponding to a movement of the object from a first location to a second location;
generating a first report having a first type, the first report including information indicating movement from the first location to the second location;
transmitting the first report to the client device if the client device has subscribed to the first report type.

12. The method of claim 11, wherein the first report is generated by a switch.

13. The method of claim 12, wherein the activity data is generated from a remote device.

14. The method of claim 13, wherein the remote device is an RFID reader.

15. The method of claim 14, wherein the object is an RFID tag.

16. The method of claim 15, wherein the first location includes a first antenna and the second location includes a second antenna, the first and second antennas being connected to the switch.

17. The method of claim 16, wherein the first and second antennas are configured to receive a first RF signal from the RFID reader to be broadcast in the respective location, the first and second antennas further configured to receive a second RF signal from the tag, the second RF signal being a response to the first RF signal, the second RF signal being transmitted to the RFID reader.

18. The method of claim 11, wherein the report is one of a XML and a TCP report.

19. The method of claim 18, wherein the report includes one of an addition report, a deletion report, and a current report.

20. A device, comprising:
a communications means for receiving user-programmable subscription data;
a storage means for storing the subscription data and configuration data; and
a processing means for generating a report from activity data as a function of the configuration data, the activity data corresponding to a movement of an object,
wherein the report includes information indicative of the movement of the object from a first location to a second location and is transmitted from the device to a client device in accordance with the subscription data.
